(19) United States
(12) Patent Application Publication
(10) Pub. No.: US 2014/0023760 A1
(43) Pub. Date: Jan. 23, 2014

(54) SYSTEM AND METHOD FOR PROCESSING COTTON GIN TRASH INTO RUMINANT ANIMAL SUPPLEMENTAL FEED

(71) Applicant: Randy Ainsworth, Frogmore, LA (US)

(72) Inventor: Randy Ainsworth, Frogmore, LA (US)

(73) Assignee: Cotton Diversified, Frogmore, LA (US)

(21) Appl. No.: 13/554,122

(22) Filed: Jul. 20, 2012

(51) Int. Cl. A23K 1/18; B29C 31/00; A23K 1/20

(52) U.S. Cl. 426/285; 426/623; 425/404

(57) ABSTRACT

A system and method for converting gin trash to a pelletized feed or supplemental feed for ruminant animals. Such a system or method may include removal of a substantial portion of the immature cotton fiber content from the gin trash in order to ensure the consistency of the pellets produced. The processed gin trash may be mixed with cottonseed meal and corn. The amount of cottonseed meal added may be selected such that the pellets are digestible by ruminant animals, but not non-ruminant animals. The amount of cottonseed meal added may be further selected such that the gossypol content of the pellets results in adverse health effects to non-ruminant animals if ingested.

### FIELD

The present invention relates generally to the field of cotton gin trash, and more particularly, to a system and method for processing cotton gin trash into a supplemental feed for ruminant animals.

### BACKGROUND

Cotton gin by-product, also known as “gin trash,” has long been a nuisance to the cotton industry. Cotton production and processing are important to the economy of the United States, and particularly to that of the southern states, from Florida to California. Over the past ten years, an average of over 13 million acres of cotton was planted annually in the United States with an average yield of 1.5 to 2 bales per acre. With every bale produced, a significant amount of by-product or “gin trash” is also produced. The amount of gin trash produced per bale varies with the method of harvesting. Spindle-harvested (i.e., harvested by mechanical cotton picker) cotton typically results in 75 to 200 lbs of gin trash per bale. Stripper-harvested cotton may result in 300 to 800 lbs of gin trash per bale. The amount of trash produced by strippers is largely dependent upon whether the stripper includes any extractors or other cleaning devices. Every year the cotton industry must dispose of millions of pounds of gin trash.

The by-product of the ginning process is generally composed of dirt, fragments of burs, stems, immature cottonseed, lint, immature cotton fiber, leaf fragments, and other extraneous plant parts. Common methods of gin trash disposal include direct land application, composting, and donation to cattle farmers for use as a roughage feed ingredient or supplement. However, due to the availability of large quantities of gin trash, several attempts have been made to leverage gin trash as a valuable commodity. Such attempts have included processing gin trash into combustible briquettes for use in certain types of stoves (offering an alternative to fossil fuels), using gin trash as a component in building materials, using gin trash as a mulch for erosion prevention, and using gin trash as a soil supplement.

### SUMMARY

It is desirable to use cotton gin trash as a low-cost feed (or feed supplement) for livestock, given its widespread availability and its utility as a low-nutrient roughage. Moreover, the presence of the chemical gossypol in gin trash makes cotton by-product particularly desirable as a feed or feed supplement for ruminant animals.

Gossypol is a naturally occurring toxin present within cotton plants that protects the plants from insect damage, the largest concentrations of which may be found in the seeds and the roots of cotton plants. Gossypol exists in two forms: free and bound. The free form is toxic, while the gossypol that binds to proteins is in the “bound,” non-toxic form. While free gossypol is toxic to non-ruminant animals, ruminant animals possess the ability to detoxify it and thus are only mildly susceptible to its effects at higher concentrations.

It is further desirable to process gin trash into a livestock feed or feed supplement in the form of a pellet. Pellets are easy to handle and the pelletizing process allows for the blending of other materials with the gin trash.

Previous attempts to process gin trash into a feed or feed supplement in pellet form have proven unsuccessful. These attempts were abandoned for two primary reasons: 1) the costs of grinding and extruding exceeded the economic value of the finished product, making such products more expensive than other types of available roughages; and 2) the pellets produces often failed to hold their shape and consistency, and were prone to falling apart.

It is an object of the present invention to provide a system and method for manufacturing a pelletized gin trash product configured for use as a feed or supplemental feed for ruminant animals. It is a further object of this invention that such system, method, and product be configured such that the product is palatable to ruminant animals, but unattractive to non-ruminant animals. It is a further object of this invention that such product may be used as an attractant for ruminant animals but configured such that non-ruminant animals will either ignore it or suffer negative health effects if it is ingested.

The present disclosure provides a system and method for converting gin trash into a pelletized feed or feed supplement for ruminant animals. According to an exemplary embodiment of the present invention, a system or method are provided that remove at least seventy-five percent of the immature cotton fiber from a quantity of gin trash. Such removal may be accomplished with a stick machine. The processed gin trash may then be mixed with additional materials, such as corn and/or cottonseed meal. The mixture is then ground to a powder and pelletized in a pelletizer. The amounts of corn and/or cottonseed meal may be selected in order to achieve a desired gossypol level and protein content. The gossypol level may be set such that the feed/feed supplement is digestible by ruminant animals but not by non-ruminant animals, and the desired protein content may be at least fifteen percent.

A method for manufacturing a feed may involve processing gin trash through a stick machine having a rotating saw cylinder and a grid bar such that the stick machine removes a portion of the immature cotton fiber content of the gin trash; moving the processed gin trash to a mixer and adding corn and cottonseed meal; mixing the processed gin trash, corn, and cottonseed meal; grinding the mixture with a mill to form a powder; and pelletizing the powder. The stick machine may be configured such that at least seventy-five percent of the immature fiber content of the gin trash is removed. The tip speed of the rotating saw cylinder may be from 500 feet per minute to about 1000 feet per minute, and the grid bar may be positioned no more than about 0.5 inches from the saw cylinder.

A system for manufacturing a feed may include a stick machine, a mixer, a mill, and a pelletizer. The stick machine removes a portion of the immature cotton fiber content of gin trash. The mixer blends the processed gin trash with at lest one additional ingredient, such as corn and/or cottonseed meal. The mill grinds the mixture into a powder, and the pelletizer compresses the powder into pellets. The stick machine may be a double-saw stick machine, and the mill may be a hammermill.

A pelletized feed or feed supplement for ruminant animals may include a mixture of gin trash, corn and cottonseed meal. The gin trash may be processed such that a portion of the immature cotton fiber content has been removed. The ratio of corn to processed gin trash may be about 1:15, and the ratio of cottonseed meal to gin trash may be about 1:1. The amount of cottonseed meal added to the mixture may be such that the gossypol level of the feed is from about 1 gram/pound to over 5 grams/pound, depending on the desired effect on non-ruminant animals that ingest the feed. The diameter of such a feed pellet may be from about 0.2 inches to about 0.5 inches, and the length of the pellet may be from about 0.2 inches to about 1.0 inches. Corn stalks or rice stray may be substituted for gin trash.

### BRIEF DESCRIPTION OF THE DRAWINGS

FIG. 1 is a schematic diagram of a system for manufacturing a feed or feed supplement for ruminant animals, according to an exemplary embodiment of the present invention.

FIG. 2 is a diagram of a stick machine, according to an exemplary embodiment of the present invention.

FIG. 3 is a photograph of feed supplement pellets, according to an exemplary embodiment of the present invention.

### DETAILED DESCRIPTION

According to an exemplary embodiment of the present invention, in preparing gin trash for processing into pellets for use as a feed or feed supplement, the removal of a portion of the immature/short fiber from the gin trash has the surprising result of a pelletized product that does not lose its consistency, shape, or otherwise fall apart. According to an exemplary embodiment of the present invention, a method for preparing supplemental feed pellets may begin with the cleaning of a quantity of gin trash to remove all or a portion of the immature cotton fiber content of the gin trash. In certain embodiments, at least seventy-five percent of the immature fiber content is removed from the gin trash.

In an exemplary embodiment of the present invention, the quantity of gin trash may be cleaned, and all or a portion of the immature fiber removed, by processing the gin trash in a stick machine. A stick machine is a device used in the processing of harvested cotton for removing extra foreign matter (i.e., gin trash) taken up by mechanical harvesters. A stick machine may include one or more high-speed saw cylinders, one or more stationary wire brushes, and/or one or more grid bars. The centrifugal force created by the rotating saw cylinder(s) slings off foreign material (gin trash), while the cotton fiber is held by the saw. As harvested cotton enters a stick machine, seed cotton is wiped onto the cylindrical saw teeth by wire brushes. Grid bars or stationary wire brushes may be positioned around the saw cylinder(s) to reduce the amount of seed cotton thrown off the cylinder. Some embodiments of stick machines may have more than one saw cylinder. In addition to the primary saw cylinder, some stick machines may have one or more reclaimer saws configured to capture seed cotton thrown off with foreign matter (gin trash) by the primary saw cylinder. Reclaimer saw cylinders are similar to the main saw cylinder, but typically run slower and have more grid bars.

According to an exemplary embodiment of the present invention, by feeding cotton by-product/gin trash through a stick machine and adjusting the saw and grid bar settings, a portion of the immature fiber content of the gin trash can be removed. Pellets manufactured from the processed gin trash maintain their consistency and do not fall apart over time—a problem that plagued earlier attempts to create a pelletized gin trash feed/feed supplement. Thus, according to an exemplary embodiment of the present invention, a quantity of gin trash is first fed through a stick machine, wherein the machine is configured such that a portion of the immature cotton fiber content is removed from the gin trash. In some embodiments, the stick machine may be configured to remove at least seventy-five percent of the immature fiber content of the quantity of gin trash. Removal of the immature cotton fiber from the gin trash may be accomplished by adjusting the settings of at least one of the cylinder saw(s), the reclaimer saw(s), the position of the grid bars, and the position of the wire brushes(s). The cylinder saw(s) and/or reclaimer saw(s) may be adjusted by lowering the running speed (RPMs) from the speeds used when processing harvested cotton. In one embodiment, the speed of the stick machine saws are lowered by about 125 RPMs from the speed used for harvested cotton. Such speeds ensure that an optimal amount of immature cotton fiber is transferred from the saws to the wire brushes, thus separating it from the processed gin trash.

In some embodiments of the present invention, the speed of the cylinder saw(s) and/or the reclaimer saw(s) may be set by selecting an appropriate tip speed. Tip speed is the rotational speed of a tip of a rotating saw. According to an exemplary embodiment of the present invention, the tip speed of the cylinder saw(s) and/or the reclaimer saw(s) may be selected from the range of 500 feet per minute to 1000 feet per minute.

Further embodiments of the present invention may also include one or more grid bars positioned around the cylindrical saw(s) and/or the reclaimer saw(s). These grid bars may be configured to ensure that processed gin trash is thrown away by the centrifugal force generated by the saw(s), while immature cotton fiber is retained beneath the grid bars. In certain embodiments of the present invention, such grid bars may be spaced no more than about 0.5 inches from the saw tips.

The processed gin trash may then be moved into a mixer, where one or more additional ingredients may be added. According to an exemplary embodiment of the present invention, cottonseed meal may be added to the processed gin trash to form a mixture. Cottonseed meal is the by-product remaining after cottonseed oil has been extracted from whole cottonseeds. When added to the mixture, cottonseed meal acts as a lubricant, helps to hold the finished pellets together, maintains consistency, increases protein content of the mixture (thereby increasing the product's nutritional value), and increases the gossypol content of the mixture (thereby deterring non-ruminant animals from eating the pellets). The gossypol content of the cottonseed meal may vary depending upon the manner the meal was processed. Techniques where heat is applied, such as a screw-press method, generally yield a meal with less free gossypol content, as heat converts free-gossypol to bound gossypol. Techniques where no heat is used, such as solvent extraction, generally yields cottonseed meal with higher free-gossypol levels.

According to an exemplary embodiment of the present invention, a quantity of cottonseed meal may be added to the processed gin trash to form a mixture such that the gossypol content of the mixture is tolerable to ruminant animals, but not to simple-stomached, non-ruminant animals. In some embodiments of the present invention, the ratio of cottonseed meal to gin trash may be up to 1:1, and the gossypol content of the mixture (and thus the finished pellets) is such that non-ruminants will avoid the pellets.

In certain embodiments of the present invention, the amount of cottonseed meal added to the mixture may be selected such that the gossypol content of the feed results in adverse health effects to non-ruminant animals that ingest the feed. Such adverse health effects may include sterilization and death. In such embodiments, the gossypol content of the feed may be from about 2 grams per pound to about 5 grams per pound in order to result in the sterilization of non-ruminant animals, and greater than 5 grams per pound in order to result in the death of non-ruminant animals. In other embodiments wherein it is desired that the feed simply be undesirable to non-ruminant animals, the gossypol content of the feed may be from about 1 gram per pound to about 2 grams per pound.

In further embodiments of the present invention, corn may be added to the mixture. Corn may increase the nutritional value of the mixture, as well as act as a cleaning agent to clean the mill through which the mixture will pass after the mixing step. In an exemplary embodiment of the present invention, corn may be added to the mixer at about a 1:15 ratio with the quantity processed gin trash. The quantity of the corn and/or the cottonseed meal may be selected such that the protein content of the mixture is maintained at a desired level for nutritional purposes. In certain embodiments the protein content of the mixture is at least fifteen percent.

After the ingredients have been mixed, the mixture is then transferred into a mill for grinding. In certain embodiments, the mill is a hammermill. After milling, the mixture may be transferred to a holding tank and then augered into a pelletizer. In certain embodiments of the present invention, the mixture may be transferred to a holding tank, container, or other such storage object by blowing. The pelletizer may be configured to produce pellets of an appropriate size for livestock feed. In some embodiments, the pellets may be about 0.2 inches to about 0.5 inches in diameter, and about 0.2 inches to about 1.0 inches in length.

According to an exemplary embodiment of the present invention, a supplemental feed for ruminant animals may be a plurality of pellets that include gin trash, corn, and cottonseed meal. The gin trash may have been processed such that up to seventy-five percent of immature fiber content was removed. In some embodiments, the ratio of corn to gin trash is about 1:15, and the ratio of cottonseed meal to gin trash is no greater than 1:1. In further embodiments, the quantity of cottonseed meal may be selected such that the pellets are digestible by ruminant animals, but not by non-ruminant animals. In still further embodiments, the quantity of cottonseed meal may be selected such that consumption by non-ruminant animals results in adverse health effects, including, but not limited to, sterilization and death. Embodiments of the present invention may be a feed or supplemental feed for livestock ruminant animals, while other embodiments may be an attractant for ruminant animals and configured such that non-ruminant animals will refuse to eat or otherwise avoid the attractant.

Like reference characters denote like parts in the drawings.

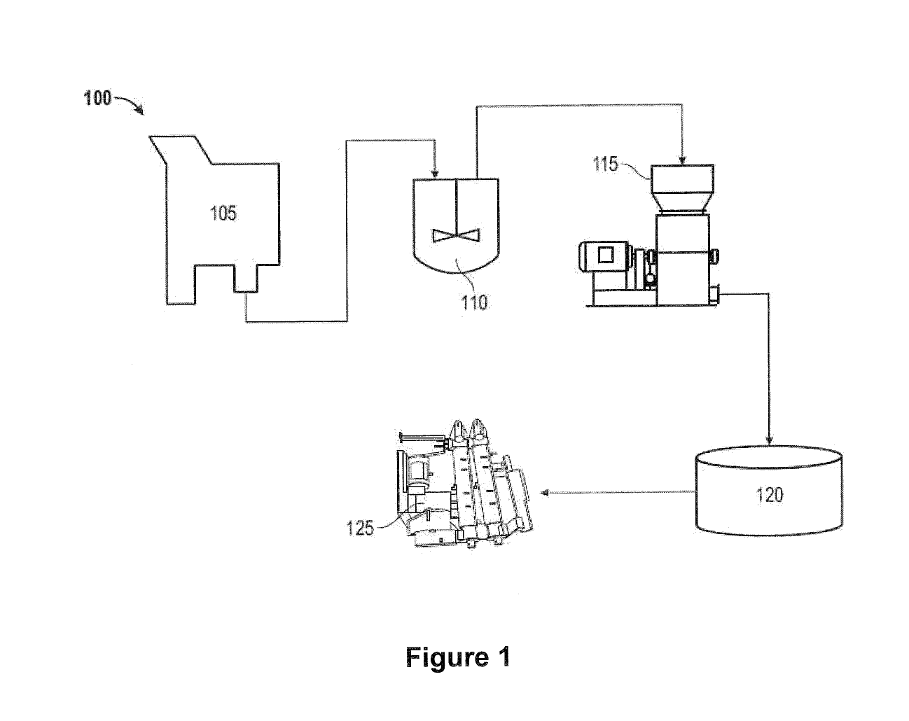

FIG. 1 illustrates a system 100 for manufacturing a feed or feed supplement for ruminant animals, according to an exemplary embodiment of the present invention. A quantity of gin trash may first be processed by stick machine 105. Stick machine 105 may be configured to remove a portion of the immature cotton fiber content of the quantity of gin trash. In certain embodiments, stick machine 105 is configured to remove at least seventy-five percent of the immature cotton fiber content of the quantity of gin trash. In some embodiments, stick machine 105 may be a double-saw stick machine.

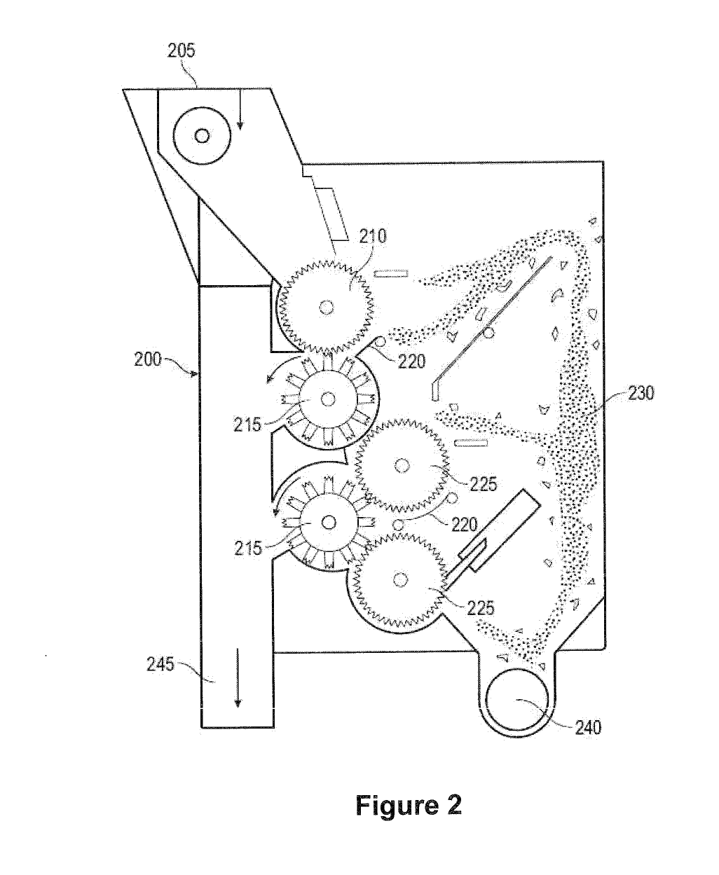

FIG. 2 is a diagram of a stick machine 200 according to an exemplary embodiment of the present invention. Gin trash enters stick machine 200 at intake 205, after which it contacts at least one rotating saw cylinder 210. One or more brushes 215 and/or one or more grid bars 220 may be positioned around rotating saw cylinder 210. As gin trash contacts rotating saw cylinder 210, immature cotton fiber is confined by the one or more brushes 215 and/or the one or more grid bars 220, while the processed gin trash 230 is slung away from rotating saw cylinder 210. Some embodiments of stick machine 200 have one rotating saw cylinder 210, while others contain more than one. Additionally, some embodiments of stick machine 200 further contain at least one reclaimer saw 225 to capture additional cotton fiber not captured by rotating saw cylinder 210 and/or the associated brushes 215 or grid bars 220. Processed gin trash 230 exits stick machine 200 via exit 240, while immature cotton fiber may exit stick machine 200 via exit 245. In certain embodiments of the present invention, the tip speed of saw cylinder 210 and/or reclaimer saw 225 may be selected from the range of 500 feet per minute to 1000 feet per minute, and the one or more grid bars 220 may be set no more than approximately 0.5 inches from saw cylinder 210 and/or reclaimer saw 225.

The processed gin trash may then be moved, via manual or automatic means, to mixer 110. According to certain embodiments of the present invention, one or more additional ingredients may be added to the processed gin trash in mixer 110 to form a mixture. In an exemplary embodiment of the present invention, a quantity of cottonseed meal is added to the processed gin trash in mixer 110. The quantity of cottonseed mixture may be selected such that the gossypol concentration of the mixture is such that the mixture is digestible by ruminant animals, but not by non-ruminant animals. In further embodiments, the quantity of cottonseed meal is selected such that the mixture causes adverse health effects when consumed by non-ruminant animals. Such adverse health effects may include, but are not limited to, sterility and death. In some embodiments, the ratio of cottonseed meal to gin trash is no more than 1:1.

According to an exemplary embodiment of the present invention, a quantity of corn may be added to the processed cotton in mixer 110. In some embodiments, the quantity of corn is added at a ratio of about 1:15 with the processed gin trash. In further embodiments, quantities of both corn and cottonseed meal are added to the processed gin trash in mixer 110 to form a mixture. The quantity of at least one of the corn and the cottonseed meal may be selected such that the protein content of the mixture is at least fifteen percent.

The processed gin trash and any additional ingredients may be mixed in mixer 110 for a certain period of time prior to being moved, via manual or automatic means, into mill 115. In certain embodiments, the processed gin trash and additional ingredients may be mixed for about twenty minutes. Once delivered to mill 115, the mixture is ground such that it forms a powder. In an exemplary embodiment of the present invention, mill 115 is a hammermill.

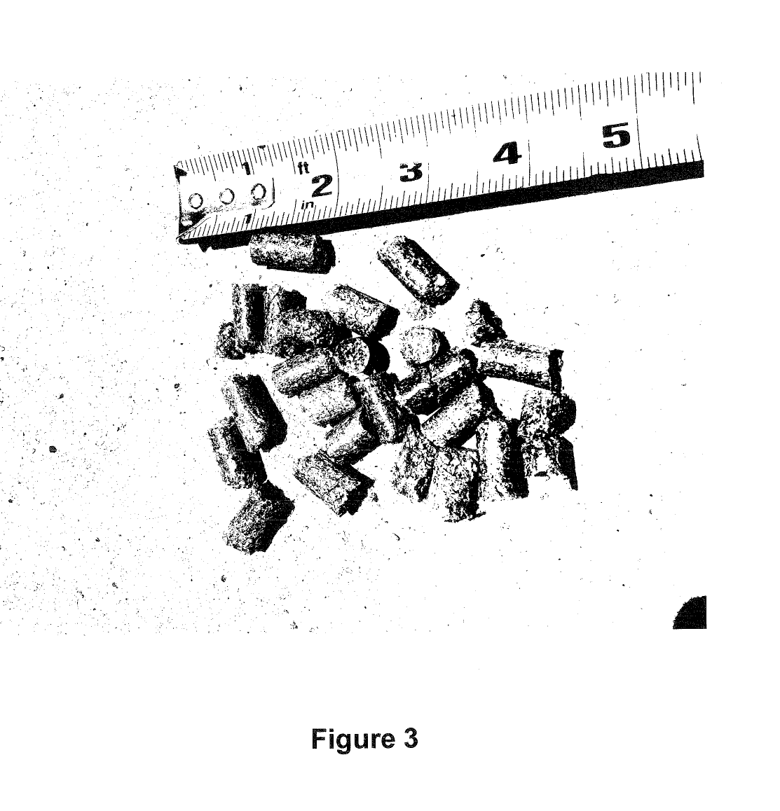

From mill 115, the powder may be moved into either holding tank 120 and to pelletizer 125. In some embodiments the powder may be moved from mill 115 to holding tank 120 by blowing. In other embodiments, the powder may be moved from mill 115 or holding tank 120 to pelletizer 125 via an auger, or other such mechanical means. Pelletizer 125 is configured to compress the powder into a plurality of pellets. In an exemplary embodiment of the present invention, the size of each of the plurality of pellets is selected to be of a suitable size for animal feed. In some embodiments, the diameter of the pellets may be from about 0.2 inches to about 0.5 inches, and the length of the pellets may be from about 0.2 inches to about 1.0 inches. An exemplary embodiment of such pellets is displayed in FIG. 3.

While the embodiments are described with reference to various implementations and exploitations, it will be understood that these embodiments are illustrative and that the scope of the invention(s) is not limited to them. In general, embodiments of a system and method for processing gin trash into ruminant animal feed or feed supplement, as well as the associated product as described herein, may be implemented using methods, facilities, and devices consistent with any appropriate hardware or software systems or a combination thereof. Many variations, modifications, additions, and improvements are possible. For example, certain embodiments of the present invention may substitute other roughage for gin trash, such as corn stalks or rice straw.

What is claimed is:

1. A method for manufacturing a feed, comprising:
a. processing an amount of gin trash through a stick machine having a rotating saw cylinder and a grid bar, wherein the stick machine removes a portion of an immature cotton fiber content of the gin trash thereby forming processed gin trash;
b. moving the processed gin trash to a mixer;
c. adding an amount of corn to the mixer;
d. adding an amount of cottonseed meal to the mixer;
e. mixing the processed gin trash, the corn, and the cottonseed meal in the mixer to form a mixture;
f. moving the mixture to a mill;
g. grinding the mixture with the mill to form a powder;
h. moving the powder to a pelletizer; and
i. processing the powder with the pelletizer to form a plurality of pellets each of said plurality of pellets having a diameter and a length.

2. The method of claim 1, wherein the portion of the immature cotton fiber content of the gin trash removed is at least about seventy-five percent.

3. The method of claim 1, wherein the ratio of corn to processed gin trash is about 1:15, and the ratio of cottonseed meal to gin trash is no more than about 1:1.

4. The method of claim 1, wherein the amount of cottonseed meal is such that the gossypol level of the supplemental feed pellets is from about 1 gram/pound to 2 grams/pound.

5. The method of claim 1, wherein the amount of cottonseed meal is such that the gossypol level of the supplemental feed pellets is from about 2 grams/pound to about 5 grams/pound.

6. The method of claim 1, wherein the amount of cottonseed meal is such that the gossypol level of the supplemental feed pellets is greater than 5 grams/pound.

7. The method of claim 1, wherein at least one of the corn and the cottonseed meal is of an amount such that the protein content of the mixture is at least fifteen percent.

8. The method of claim 1, wherein the stick machine is a double-saw stick machine.

9. The method of claim 1, wherein the mill is a hammermill.

10. The method of claim 2, wherein the tip speed of the rotating saw cylinder is selected from the range of about 500 feet per minute to about 1000 feet per minute.

11. The method of claim 10, wherein the grid bar is positioned no more than about 0.5 inches from the rotating saw cylinder.

12. The method of claim 1, wherein the diameter of each of the plurality of pellets is from about 0.2 inches to about 0.5 inches and the length of each of the plurality of pellets is from about 0.2 inches to about 1.0 inches.

13. The product of the process of claim 1.

14. A feed, consisting essentially of:
gin trash;
corn; and
cottonseed meal,
wherein the gin trash, corn, and cottonseed meal are combined to form a pellet, and wherein the gin trash as been processed such that a portion of immature cotton fiber content has been removed.

15. The feed of claim 14, wherein the ratio of corn to gin trash is about 1:15, and the ratio of cottonseed meal to gin trash is no more than 1:1.

16. The feed of claim 14, wherein the portion of the immature cotton fiber content removed is at least about seventy-five percent.

17. The feed of claim 14, wherein the cottonseed meal is of an amount such that the gossypol level of the feed is from about 1 gram/pound to 2 grams/pound.

18. The feed of claim 14, wherein the amount of cottonseed meal is such that the gossypol level of the feed is from about 2 grams/pound to about 5 grams/pound. digestible by ruminant animals but renders non-ruminant animals sterile.

19. The feed of claim 14, wherein the amount of cottonseed meal is such that the gossypol level of the feed is greater than 5 grams/pound.

20. The feed of claim 14, wherein the diameter of the pellet is from about 0.2 inches to about 0.5 inches and the length of the pellet is from about 0.2 inches to about 1.0 inches.

21. A feed for ruminant animals, comprising:
gin trash;
corn; and
cottonseed meal,
wherein the gin trash has been processed such that a portion of an immature cotton fiber content of the gin trash has been removed, and wherein the feed is a pellet.

22. The feed of claim 21, wherein the ratio of corn to gin trash is about 1:15, and the ratio of cottonseed meal to gin trash is no more than 1:1.

23. The feed of claim 21, wherein the portion of the immature cotton fiber removed is at least about seventy-five percent.

24. The feed of claim 21, wherein the cottonseed meal is of an amount such that the gossypol level of the feed is from about 1 gram/pound to 2 grams/pound.

25. The feed of claim 21, wherein the amount of cottonseed meal is such that the gossypol level of the feed is from about 2 grams/pound to about 5 grams/pound.

26. The feed of claim 21, wherein the amount of cottonseed meal is such that the gossypol level of the feed is greater than 5 grams/pound.

27. The feed of claim 21, wherein the diameter of the pellet is from about 0.2 inches to about 0.5 inches and the length of the pellet is from about 0.2 inches to about 1.0 inches.

28. The feed of claim 21, wherein at least one of corn stalks and rice straw is substituted for gin trash.

29. A system for manufacturing feed, comprising:
a stick machine;
a mixer;
a mill; and
a pelletizer,
wherein the stick machine removes a portion of an immature cotton fiber content of gin trash;
wherein the mixer blends the gin trash with at least one additional ingredient to form a mixture;
wherein the mill grinds the mixture into a powder; and
wherein the pelletizer compresses the powder into a plurality of pellets.

30. The system of claim 29, wherein the stick machine is a double-saw stick machine.

31. The system of claim 29, wherein the mill is a hammermill.

32. The system of claim 29, wherein the diameter of each of the plurality of pellets is from about 0.2 inches to about 0.5 inches and the length of each of the plurality of pellets is from about 0.2 inches to about 1.0 inches.
